(19) United States
(12) Patent Application Publication
(10) Pub. No.: US 2020/0276873 A1
(43) Pub. Date: Sep. 3, 2020

(54) BI-MATERIAL CAGE COMPRISING BEARINGS, FOR A BALL JOINT

(71) Applicant: JTEKT EUROPE, Irigny (FR)

(72) Inventor: Philippe DURAND, Villeurbanne (FR)

(73) Assignee: JTEKT EUROPE, Irigny (FR)

(21) Appl. No.: 16/645,678

(22) PCT Filed: Aug. 29, 2018
(86) PCT No.: PCT/FR2018/052123

§ 371 Date: Mar. 9, 2020

(30) Foreign Application Priority Data
Sep. 21, 2017 (FR) 1758746

(51) Int. Cl. B60G 7/00; B29C 45/14

(52) U.S. Cl. CPC B60G 7/005; B29C 45/14467; B29L 2031/04; B60G 2204/416; B60G 2206/81012; B29C 45/14754

(57) ABSTRACT

A method for producing a cage for a ball joint of a vehicle that includes a step of injecting a first material via a first injection point so as to form a shell that encloses at least one housing, on a substantially spherical inner surface and a step of injecting a second material via a second injection point so as to form a contact zone in the housing of the shell.

The invention concerns the field of cages for a ball joint of a vehicle such as, a steering ball joint or a suspension ball joint.

Generally, a tie rod of a vehicle is connected by its ends to a rack on the one hand and to a wheel on the other hand. Each of the connections is a spherical connection made by means of a ball joint completely connecting two parts in translation and allowing said two parts to be rotated together.

The two component parts of a ball joint are a cage and a head.

The cage comprises a substantially spherical cavity intended to receive and hold the head. The spherical cavity is delimited by a bottom and by retaining tabs extending from the bottom.

The head is a pivot provided with a substantially spherical head intended to be introduced into the cavity, that is to say between the retaining tabs of the cage.

To allow resistance of the ball joint to forces and temperatures undergone during the operation of the vehicle and therefore of the ball joint, the use of a rigid material is sometimes necessary.

It is known from the state of the art to produce the cage in a material whose Youngs modulus is greater than 10,000 MPa such as polyetheretherketone (PEEK) or a mixture of polymers from the group of polyphthalam ides (PPA) loaded with glass or carbon fibers for example. Such material will be called rigid in the following description.

However, the low flexibility of the retaining tabs constituting the cage makes the assembly of the head in the cage difficult. Indeed, the introduction of the head into the spherical cavity causes a high stress concentration at the base of the retaining tabs which may create cracks causing a risk of rupture.

Furthermore, the use of a rigid material can cause a jerky movement between the head and the cage, called stick-slip phenomenon, during the operation of the vehicle. This phenomenon generates in particular noise nuisance.

It is also known from the state of the art to produce the cage for a ball joint in a material whose Youngs modulus is in the range of 3,000 MPa such as polyoxymethylene (POM). Such material will be called flexible in the following description.

The sliding properties of a flexible material allow to limit the friction between the cage and the head and thus avoid the stick-slip phenomenon.

However, a thermal stress associated with a mechanical force causes a flow of a flexible material. Thus, a clearance can be created between the head and the cage, limiting the possible fields of application of such a cage for a ball joint.

The invention aims to remedy all or part of the aforementioned drawbacks by proposing a method for manufacturing a cage for a ball joint of a vehicle, comprising:
a step of injecting a first material through a first injection point, so as to form a shell comprising at least one housing on a substantially spherical inner surface;
a step of injecting a second material through a second injection point, so as to form a contact zone in the housing of the shell.

The shell of the cage for a ball joint is shaped with said first material during the step of injecting a first material. The shell comprises a cavity having a substantially spherical inner surface on which at least one housing extends. The term housing means a recess formed in a thickness of the shell.

During the step of injecting a second material, the at least one housing of the shell is filled with the second material.

Thus, the first material and the second material of the cage for a ball joint are inseparable. This allows to facilitate the assembly of the cage with a head so as to form a ball joint. Furthermore, the assembly of two materials allows obtaining a cage for a ball joint including mechanical characteristics of the first material and sliding properties of the second material.

According to a characteristic of the invention, the second material circulates in at least one channel between the second injection point and the at least one housing.

Thus, the second material is guided from the second injection point up to the housing through the channel.

Preferably, the second injection point is formed in the thickness of the shell.

According to a characteristic of the invention, the second material circulates in a plurality of channels between the second injection point and a plurality of housings or/and between a plurality of housings.

Thus, the injection of the second material at an injection point allows filling all the housings. The manufacture of the cage is carried out by two steps of material injection at two distinct injection points.

According to a characteristic of the invention, the manufacturing method comprises, after the step of injecting a first material, a step of ejecting the shell from a first mold and a step of positioning the shell in a second mold.

The first mold allows the creation of at least one housing on the inner surface of the shell cavity. Thus, the first mold comprises a first female portion cooperating with a first core. The first core comprises a substantially spherical element over which at least one shoulder corresponding to the at least one housing extends. The term «shoulder» means a projecting surface.

After cooling and solidification of the first material, the shell is ejected from the first mold and then repositioned in the second mold.

The second mold comprises a second female portion cooperating with a second core. The second female portion preferably comprises the second injection point. The second core comprises a substantially spherical element over which at least one recess corresponding to the at least one housing so as to allow the manufacture of at least one contact zone in relief relative to the inner surface of the shell preferably extends.

According to another embodiment, the manufacturing method comprises, after the step of injecting a first material, a step of extracting a first core of a mold from the shell and a step of inserting a second core into the shell.

Thus, after cooling and solidification of the first material, the first core of the mold is extracted from the shell and then the second core of the mold is inserted into the shell in place of the first core.

In this embodiment, the first core and the second core are mounted on a rotary axis allowing the insertion, in turn, of the first core and then of the second core.

The invention also relates to a cage for a ball joint of a vehicle manufactured by the method according to the invention including a shell made of a first material and at least one contact zone made of a second material positioned integrally on a substantially spherical inner surface of the shell.

Thus, the shell is produced in a single piece having mechanical properties of the first material and sliding properties of the second material.

For example, the cage for a ball joint has mechanical robustness allowing resistance to the forces and temperatures undergone during its operation and sliding properties allowing to avoid the stick-slip phenomenon between the cage and the head for a ball joint.

According to a characteristic of the invention, the at least one contact zone is surrounded by the inner surface of the shell.

Thus, the second material cannot flow so as to create a clearance between the cage for a ball joint and the head for a ball joint.

Indeed, during a thermal stress associated with a mechanical force, the second material is maintained by the first material constituting the inner surface of the shell.

According to a characteristic of the invention, the at least one contact zone forms a relief relative to the inner surface.

Thus, the head for a ball joint is only in contact with the at least one contact zone having a coefficient of friction reduced relative to the coefficient of friction of the inner surface.

Furthermore, when assembling the cage with the head to form a ball joint, the at least one contact zone is partially crushed so that the head will be perfectly in contact with the at least one contact zone of the cage for a ball joint.

According to a characteristic of the invention, the cage for a ball joint comprises a plurality of contact zones.

Thus, the contact zones are better distributed over the inner surface of the cage.

Furthermore, the contact zones have a smaller size reducing the risk of flow of the second material.

According to a characteristic of the invention, the at least one contact zone is connected to a second injection point by at least one channel.

Thus, during the manufacture of the cage for a ball joint, the second material constituting the contact zones is injected at a single location and then diffuses through the at least one channel so as to fill all of the contact zones.

According to a characteristic of the invention, a plurality of contact zones are connected to each other by a plurality of channels.

According to a characteristic of the invention, the at least one channel is in the same plane as the inner surface.

Thus the at least one channel is located in a zone where there is no contact with the head for a ball joint.

According to a characteristic of the invention, the first material is a material whose Young modulus is greater than 10,000 MPa.

Thus, the first material allows resistance of the cage for a ball joint to the forces and temperatures undergone during its operation in a vehicle direction.

According to a characteristic of the invention, the second material is a material whose Young modulus is in the range of 3,000 MPa.

Thus, the second material allows limiting the friction between the cage and the head for a ball joint and avoids the stick-slip phenomenon.

The invention will be better understood, thanks to the following description, which relates to an embodiment according to the present invention, given by way of non-limiting examples and explained with reference to the appended schematic drawings, in which:

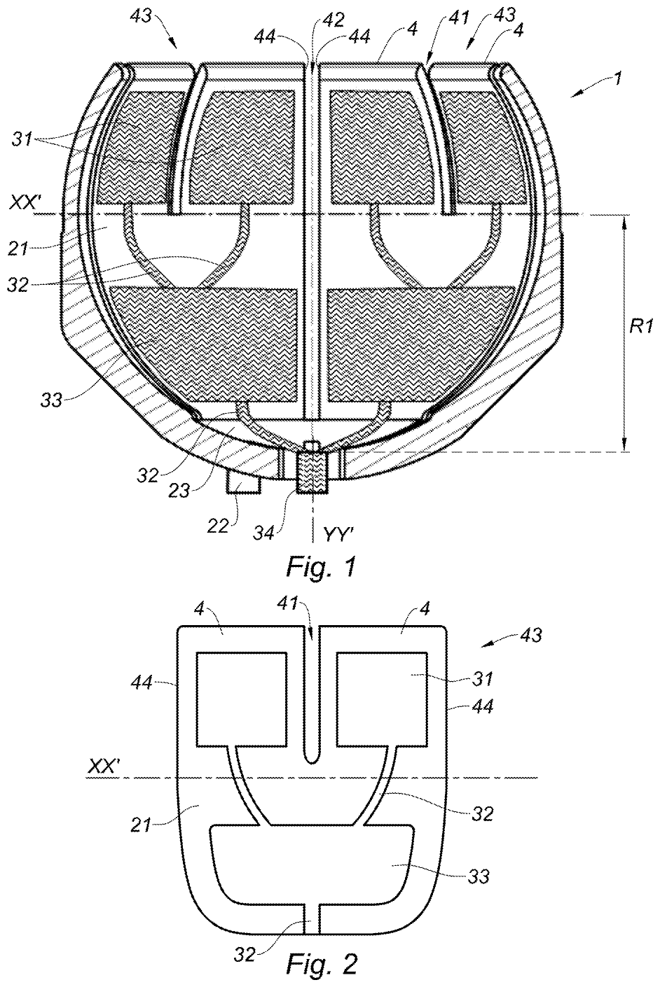

FIG. 1 is a sectional view of a shell for a ball joint according to the invention;

FIG. 2 is a retaining tab of a shell for a ball joint according to the invention.

A shell 1 for a ball joint, as represented in FIG. 1, is manufactured using a method comprising a step of injecting a first material.

The first material constituting the shell 1 has mechanical properties allowing resistance of the shell 1 to mechanical forces and temperatures undergone in a vehicle power steering system. The Young modulus of the first material is greater than 10,000 MPa such as polyetheretherketone (PEEK) or a mixture of polymers from the group of polyphthalamides (PPA) loaded with glass or carbon fibers for example.

The first material is injected through a first injection point 22 in liquid to viscous form into a mold. The mold comprises a female portion cooperating with a first core. The female portion comprises a spherical cavity and the first injection point 22. The first core comprises a spherical element, cooperating with the spherical cavity of the female portion, on which shoulders extend.

The shell 1 produced during the step of injecting a first material comprises a substantially spherical cavity with a defined radius R1 having a substantially circular opening. The cavity is formed by 5 identical retaining tabs 43, as can be seen in FIG. 2, extending in a homogeneous manner from a bottom 23 opposite the opening. The bottom 23 comprises the first injection point 22.

An axis of rotation YY□ of the cavity is defined, as an axis perpendicular to the bottom 23.

An equator XX□ of the cavity is defined as an axis XX□ perpendicularly crossing the axis of rotation YY□ at a distance equal to the radius R1 of the cavity from the bottom 23.

A retaining tab 43 has a lateral edge 44 separated from a lateral edge 44 of an adjacent retaining tab 43 by a notch 42.

A portion of the retaining tab 43 comprised between the bottom 23 and the equator XX□ of the cavity will be called a lower zone and, a portion of the retaining tab 43 comprised between the equator XX□ of the cavity and the opening will be called an upper zone.

Each lower zone of a retaining tab 43 includes a housing 33 with a depth of 0.28 mm, extending 4 mm from the equator of the cavity XX□, 2 mm from the bottom 23 and 2 mm from each of the lateral edges 44 of the retaining tab 43.

Each upper zone of the retaining tab 43 includes two elongations 4 separated by a notch 41 extending along the axis of rotation YY□. Each elongation 4 includes a housing 31 with a depth of 0.28 mm, extending 1.5 mm from the equator of the cavity XX□, 1.5 mm from the opening and 1.5 mm from each of the lateral edges 44 of the elongation.

Each housing 31 of each elongation 4 of a retaining tab is connected by a channel 32 to a housing of the lower zone of the retaining tab 43, itself connected to a second injection point 34 formed in a thickness of the shell 1 on the axis of rotation YY□ by another channel 32.

The housings 33, 31 and the channels 32 are formed by the shoulders of the first core.

When the shell 1 is solidified, the manufacturing method performs a step of extracting the first core from the mold and then a step of inserting a second core into the shell 1.

The second core comprises a spherical element with a diameter substantially similar to that of the spherical element of the first core allow cooperating with the spherical cavity of the shell 1. The spherical element of the second core comprises recesses facing the housings 31, 33 of the shell 1.

Then, the manufacturing method performs a step of injecting a second material.

The second material has sliding properties better than the first material but has a Young modulus in the range of 3,000 MPa such as polyoxymethylene (POM).

Thus, the second material flows when it is subjected to mechanical and temperature stresses such as those of a vehicle steering.

The second material is injected through the second injection point 34 in liquid to viscous form into the mold. The second material flows from the second injection point 34 into the channels 32 of the shell 1 so as to fill the housings 33, 31 of the shell 1 and the recesses of the second core. Thus, the second material present in the housings 31, 33, hereinafter called contact zones, forms a relief with a thickness of 0.02 mm relative to an inner surface 21 of the retaining tabs 43. The second material present in the channels 32 is flush with the inner surface 21.

A shell 1 whose housings 31, 33 are filled with the second material will be called a cage thereafter.

When the second material is solidified, the cage is ejected from the mold.

Finally, a step of assembling the ball joint consists of inserting a head for a ball joint in the cage so as to create, for example, a vehicle steering ball joint or a suspension ball joint.

During assembly, the head for a ball joint comes into contact and partially crushes the contact zones. Thus, the head is perfectly adjusted in the cage.

When the ball joint is under compressive stress, the head is designed to come into contact with the contact zones of the lower zones of the retaining tabs 43.

When the ball joint is under tensile stress, the head is designed to come into contact with the contact zones of the upper zones of the retaining tabs 43.

Of course, the invention is not limited to the embodiments described and represented in the appended figures. Modifications remain possible, in particular from the point of view of the constitution of the various elements or by substitution of technical equivalents, without thereby departing from the scope of protection of the invention.

1. A method for manufacturing a cage for a ball joint of a vehicle, comprising:
a step of injecting a first material through a first injection point, so as to form a shell comprising at least one housing on a substantially spherical inner surface;
a step of injecting a second material through a second injection point, so as to form a contact zone in the housing of the shell.

2. The method for manufacturing a cage for a ball joint according to claim 1, wherein the second material circulates in at least one channel between the second injection point and the at least one housing.

3. The method for manufacturing a cage for a ball joint according to claim 1, comprising after the step of injecting a first material, a step of ejecting the shell from a first mold and a step of positioning the shell in a second mold.

4. The method for manufacturing a cage for a ball joint according to claim 1, comprising after the step of injecting a first material, a step of extracting a first core from a shell mold and a step of inserting a second core into the shell.

5. A cage for a ball joint of a vehicle manufactured by the method of claim 1, including a shell made of a first material and at least one contact zone made of a second material positioned integrally on a substantially spherical inner surface of the shell.

6. The cage for a ball joint according to claim 5, wherein the at least one contact zone is surrounded by the inner surface of the shell.

7. The cage for a ball joint according to claim 5, wherein the at least one contact zone forms a relief relative to the inner surface.

8. The cage for a ball joint according to claim 5, wherein the at least one contact zone is connected to a second injection point (34) by at least one channel.

9. The cage for a ball joint according to claim 8, wherein the at least one channel is in the same plane as the inner surface.

10. The cage for a ball joint according to claim 5, wherein the first material is a material whose Young's modulus is greater than 10,000 MPa.

11. The cage for a ball joint according to claim 5, wherein the second material is a material whose Young's modulus is in the range of 3,000 MPa.
